(19) United States
(12) Patent Application Publication
(10) Pub. No.: US 2013/0268138 A1
(43) Pub. Date: Oct. 10, 2013

(54) High Availability For Autonomous Machine Control System

(71) Applicants: Eric Alan Moughler, Germantown Hills, IL (US); Craig Lawrence Koehrsen, East Peoria, IL (US); Philip Henry Cole, Morton, IL (US); Timothy Francis Hufeld, Mapleton, IL (US); Bryan J. Everett, Peoria, IL (US)

(72) Inventors: Eric Alan Moughler, Germantown Hills, IL (US); Craig Lawrence Koehrsen, East Peoria, IL (US); Philip Henry Cole, Morton, IL (US); Timothy Francis Hufeld, Mapleton, IL (US); Bryan J. Everett, Peoria, IL (US)

(73) Assignee: CATERPILLAR INC., Peoria, IL (US)

(21) Appl. No.: 13/440,333

(22) Filed: Apr. 5, 2012

(51) Int. Cl. G06F 17/00

(52) U.S. Cl. 701/2

(57) ABSTRACT

A control system for a work site including an autonomous machine includes a central control system that includes a cluster of servers configured to execute an autonomous control server application on exactly one of the cluster of servers. A RAID system is in communication with the cluster of servers. A first switch interconnects a first network with the cluster of servers, and a second switch interconnects a second network with the cluster of servers. A UPS system interconnects a power source with the cluster of servers, the RAID system, and the first and second switches. The machine control system is communicatively coupled with the central control system via a wireless network and one of the first and second networks. The machine control system transmits machine position information to the autonomous control server application and receives a route plan generated by the autonomous control server application.

### TECHNICAL FIELD

The present disclosure relates generally to a control system for a work site including an autonomous machine, and more particularly to a central control system communicatively coupled with the autonomous machine having high availability.

### BACKGROUND

Utilization of autonomous machines is becoming more prevalent and offers particular advantages in the mining industry. Specifically, autonomous machines may be operated in environments unsuitable for human operators, such as, for example, at high altitudes or in sparsely populated desert regions. In addition, autonomous machines may be operated for longer periods of time than manned machines, thus providing increased productivity, and may be operated according to strict control strategies aimed at optimizing efficiency and reducing emissions. Further, by optimizing operation, maintenance costs for the autonomous machine may potentially be reduced. Work sites, such as mines, utilizing autonomous machines may incorporate a fleet of autonomous machines with a variety of semi-autonomous and manned machines. Thus, safety and reliable control of the autonomous machines is of vital importance.

Autonomous control is accomplished by providing the autonomous machine with a machine control system that includes a positioning unit and a navigation unit. The navigation unit uses machine position information generated by the positioning unit to maneuver the autonomous machine according to a route plan, which includes, for example, designated paths, routes, and hazards. In particular, the navigation unit may electronically control speed and travel direction of the machine according to the route plan to accomplish a task. The route plan may be generated and updated by a central control system that is communicatively coupled with the autonomous machine. The central control system receives machine position information from all of the machines operating at the work site and transmits an updated route plan based on this position information to the autonomous machine. Thus, the information exchange between the autonomous machine and the central control system is crucial for safe and efficient operation of the autonomous machine.

A distributed mine management system is taught in U.S. Patent Application Publication No. 2009/0096637 to Olsen et al. In particular, the mine management system in Olsen et al. includes a central computer in communication with a mobile computer supported on a mobile machine. The mobile computer receives instructions from the central computer and controls operation of the mobile machine according to the instructions. Olsen et al. also teaches a remote worksite computer having intermittent communication with the central computer via a mobile hotspot. The remote worksite computer intermittently replicates and stores data from the central computer and may communicate the replicated data to the mobile computer in the event of a loss of communication between the mobile computer and the central computer. As a result, the mobile machine may receive at least some operating instructions from the remote worksite computer during the communication loss event. If the loss of communication between the mobile computer and the central computer persists, however, it is unclear how long the remote worksite computer will facilitate continued operation of the mobile machine.

The present disclosure is directed to one or more of the problems or issues set forth above.

### SUMMARY OF THE DISCLOSURE

In one aspect, a control system for a work site including an autonomous machine includes a central control system and a machine control system. The central control system includes a cluster of servers configured to execute an autonomous control server application on exactly one of the cluster of servers. The central control system also includes a RAID system in communication with the cluster of servers, a first switch interconnecting a first network with the cluster of servers, and a second switch interconnecting a second network with the cluster of servers. A UPS system interconnects a power source with the cluster of servers, the RAID system, and the first and second switches. The machine control system is supported on a chassis of the autonomous machine and is communicatively coupled with the central control system via a wireless network and one of the first and second networks. The machine control system transmits machine position information to the autonomous control server application and receives a route plan generated by the autonomous control server application. The autonomous machine maneuvers in the work site according to the route plan.

In another aspect, a method of controlling an autonomous machine at a work site includes executing an autonomous control server application on exactly one of a cluster of servers of a central control system. Machine position information generated by a machine control system is transmitted from the autonomous machine over a wireless network and one of a first network and a second network. The first network is interconnected with the cluster of servers via a first switch, and the second network is interconnected with the cluster of servers via a second switch. The autonomous control server application receives the machine position information and transmits a route plan, which is generated by the autonomous control server application based at least in part on the machine position information, over one of the first and second networks and the wireless network. The autonomous machine receives the route plan and maneuvers the autonomous machine in the work site according to the route plan. When a failure of the exactly one of the cluster of servers is detected using a remaining subset of the cluster of servers, the autonomous control server application is automatically restarted on exactly one of the remaining subset of servers with at least one of the remaining subset of servers in response to the failure. The route plan is then updated by the autonomous control server application and transmitted over the one of the first and second networks and the wireless network.

### BRIEF DESCRIPTION OF THE DRAWINGS

FIG. 1 is a schematic diagram of an exemplary network architecture for a high availability autonomous machine control system, according to the present disclosure;

FIG. 2 is a block diagram depicting exemplary communication exchange between components of the high availability autonomous machine control system of FIG. 1, according to one aspect of the present disclosure; and

FIG. 3 is a graphical representation of a work site including an avoidance area corresponding to a lost machine, as indicated by a route plan, according to another aspect of the present disclosure.

### DETAILED DESCRIPTION

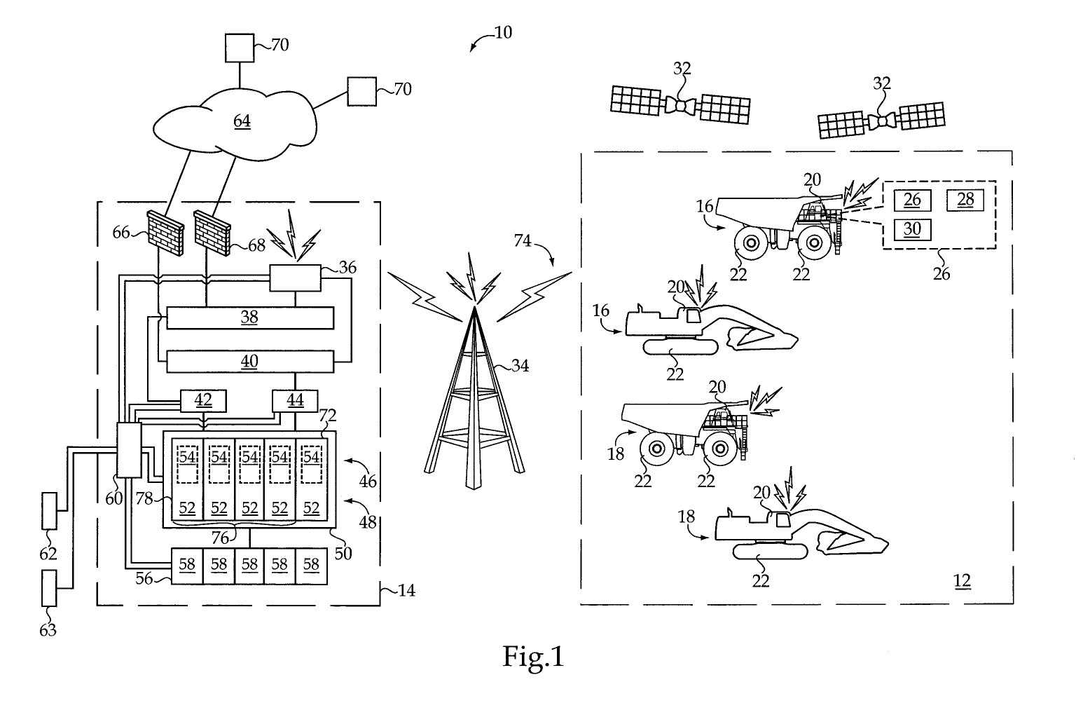

An exemplary network architecture for a high availability autonomous machine control system is shown generally in FIG. 1. In particular, a control system 10 for a work site 12 includes a central control system 14 communicatively coupled with a plurality of autonomous machines 16 and a plurality of manned machines 18 at the work site 12. According to a specific example, the work site 12 may be a mine environment utilizing heavy equipment, such as excavators, backhoes, front-end loaders, mining shovels, etc., to excavate and transport materials from a mine site to a production facility. Each of the autonomous and manned machines 16 and 18 are equipped for land based travel and include a chassis 20 supporting a plurality of ground engaging elements 22. Although specific work site and machine embodiments will be described it should be appreciated that the high availability autonomous machine control system described herein is broadly applicable to a variety of work sites including any combination of autonomous, semi-autonomous, and manned machines.

Each of the autonomous and manned machines 16 and 18 may include a machine control system 24 supported on the chassis 20. The machine control system 24 may include an electronic controller 26, a positioning unit 28, and a navigation unit 30. The electronic controller 26 is configured for drive-by-wire operation of the machine 16, 18, and, thus, is in control communication with various components of the machine 16, 18 to control at least the speed and direction of travel of the machine 16, 18. As should be appreciated, the electronic controller 26 may also be in communication with various sensors and devices in order to monitor and, thus, effectively control the operation of machine 16, 18.

The navigation unit 30 may receive, access, and/or store a route plan that is used to control operation of the machine 16, 18. For example, the route plan may include a terrain map of the work site that includes positions of the machines 16, 18, equipment, materials, hazards, etc. located at the work site. The route plan may also include a travel path associated with a task for the machine 16, 18. The navigation unit 30 is in communication with the positioning unit 28, which may include one or more Global Positioning System (GPS) units receiving information from satellites 32 to calculate machine position information. The navigation unit 30 may use the machine position information to ascertain where the machine 16, 18 is currently located and where, according to the route plan, the machine 16, 18 must go. In particular, the navigation unit 30 may extract a specific travel path for the machine 16, 18 from the route plan and communicate with the electronic controller 26 to maneuver the machine 16, 18, such as by controlling propulsion, steering, braking, and the like, according to the instructions set out for the machine 16, 18.

The electronic controller 26, the navigation unit 30, and the positioning unit 28 may each be of standard design and may include a processor, such as, for example, a central processing unit, a memory, and an input/output circuit that facilitates communication internal and external to the electronic controller. The processor may control operation of the respective electronic controller 26, navigation unit 30, or positioning unit 28 by executing operating instructions, such as, for example, computer readable program code stored in memory, wherein operations may be initiated internally or externally to the respective electronic device. A control scheme may be utilized that monitors outputs of systems or devices, such as, for example, sensors, actuators, or control units, via the input/output circuit to control inputs to various other systems or devices.

The memory may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. Such devices may be located internally or externally to the respective electronic controller 26, navigation unit 30, or positioning unit 28. One skilled in the art will appreciate that any computer based system or device utilizing similar components for controlling the components of the autonomous and manned machines 16 and 18 is suitable for use with the present disclosure.

As should be appreciated, each of the autonomous machines 16 may include other systems and/or components to effect autonomous control. For example, the autonomous machines 16 may also be equipped with inertial measurement devices, which tell the machine control system 24 how the machine 16 is moving. The machine control system 24 may also include additional obstacle detection and avoidance features, including laser, vision, and radar sensors. All of these devices may be used in known ways to maneuver the autonomous machine 16 according to instructions provided in the route plan.

The machine position information from each of the machines 16 and 18 may be transmitted from the machines 16 and 18 to the central control system 14. In particular, each machine 16, 18 may include a wireless transceiver for communicating with the central control system 14 over a wireless network, such as via a wireless communication tower 34. A wireless transceiver 36 of the central control system 14 may communicatively couple the wireless communication tower 34 with networks 38 and 40. First network 38 may include a first switch 42 interconnecting the first network 38 with a plurality of components of the central control system 14, while second network 40 may include a second switch 44 interconnecting the second network 40 with the plurality of components of the central control system 14.

It should be appreciated that each of the networks 38 and 40 may include information devices adapted to communicate over various wired or wireless media, such as, for example, cables, phone lines, fiber optic lines, radio waves, power lines, or the like. In addition, the networks 38 and 40 may communicatively interconnect some of the same components, such that some components may be configured to communicate over either of the first and second networks 38 and 40. Further, each of the networks 38 and 40 may be private, public, packet-switched, circuit-switched, local area, wide area, Internet, intranet, IP, wireless, and/or any equivalents thereof.

The central control system 14 includes a cluster of servers 46 that are interconnected. For example, the cluster of servers 46 may be interconnected to work together as a single server and, in most cases, may appear as a single server. In particular, the cluster of servers 46 may be configured such that when a failure occurs on only one of the servers in the cluster 46, the workload is redistributed to another of the servers in the cluster 46. As such, the cluster of servers 46 may provide high availability of the server system, hardware, and services utilized by the central control system 14.

According to an exemplary embodiment, the cluster of servers 46 may be implemented as a blade system 48, which, as is known by those skilled in the art, includes a chassis 50 supporting a plurality of blade servers 52. The blade servers 52 may include only the core processing elements, while the chassis 50 provides the power, cooling, connectivity, and management for each blade server 52. According to some embodiments, each of the blade servers 52, or nodes of the cluster 46, may include a virtualized server 54. Virtualized servers are known and generally include a software implementation of a server that emulates a physical server. According to a specific embodiment, a utility, such as VMWare® High Availability (HA) provided by VMWare®, headquartered in Palo Alto, Calif., may be operated on the blade servers 52 to monitor the physical servers 52 and virtual servers 54 and detect failures. In response to detected failures, VMWare® HA may restart any failed services on another server 52 or 54 of the system 48.

A RAID system 56 is in communication with the cluster of servers 46. A RAID system 56 is known in the art as a redundant array of independent disks and is a way of storing the same data in different places on multiple hard disks 58. It should be appreciated that by placing data on the multiple disks 58 performance and fault tolerance may be increased. According to some embodiments, it may be desirable to incorporate the use of a hot spare drive, which is a drive that is installed in the system 56 but remains inactive until one of the other hard disks 58 fails. Typically, the RAID system 56 is configured to automatically replace the failed disk 58 with the hot spare drive and rebuild or reconfigure the system 56 to include the hot spare drive.

A UPS system 60, as is known in the art, interconnects a power source 62 with at least the cluster of servers 46, the RAID system 56, and the first and second switches 42 and 44. The uninterruptible power supply (UPS) system 60 is a device that allows the components of the central control system 14 to keep running when primary power is lost. For example, the UPS system 60 contains an alternative power source, such as a battery, that immediately, or instantaneously, supplies power to the central control system 14 when power from the primary power is lost. It should be appreciated that the central control system 14 may also utilize an additional, or secondary power source 63, such that whenever power from the primary power source 62 is lost, power may be supplied from the secondary power source 63 automatically. Further, it may be desirable to supply power from both of the primary power source 62 and the secondary power source 63 through one or more UPS systems 60.

An additional network 64 may be communicatively coupled to first and second networks 38 and 40 via firewalls 66 and 68. Firewalls 66 and 68 may be adapted to restrict access to first and second networks 38 and 40, and may include hardware and/or software. Thus, according to some embodiments, networks 38 and 40 may represent private networks, while network 64 may represent a public network, such as, for example, the Internet. Network 64 may be accessed by one or more external or remote devices or systems 70 to communicate with one or more components of the central control system 14. It should be appreciated that the central control system 14 may interconnect or interact with a variety of other networks or systems, as required by the particular application.

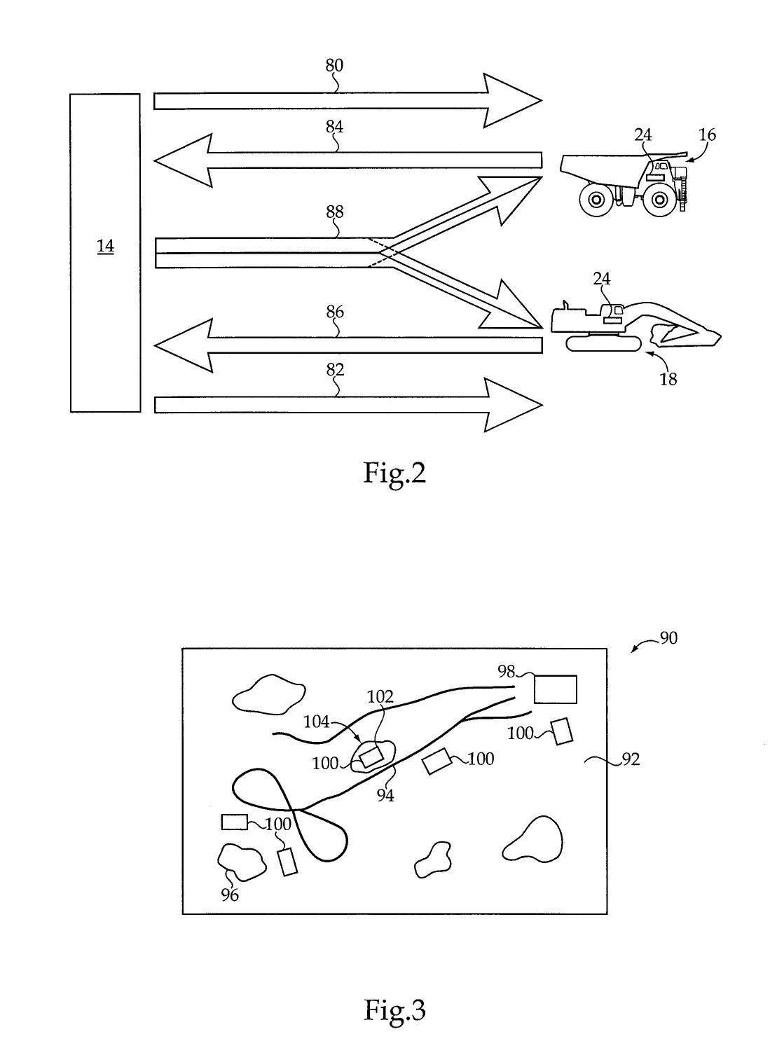

An autonomous control server application is executed on exactly one of the cluster of servers 46, such as, for example, server 72. In particular, the autonomous control server application may run on the virtual component 54 of server 72. The autonomous control server application may access one or more of the independent disks 58 of the RAID system 56 to generate and/or update a route plan for the one or more machines 16 and 18 operating at work site 12. The route plan may be transmitted as a multicast message 80, as shown in FIG. 2, and received at the autonomous and manned machines 16 and 18. In particular, the multicast message 80 may be transmitted by the autonomous control server application over one of the first and second networks 38 and 40 and the wireless network, shown generally at 74 in FIG. 1.

The route plan, contained in the multicast message 80, may be received at the machine control system 24 of each of the machines 16 and 18. Each of the machines 16 and 18 may be assigned a unique machine identifier, and the machine control system 24 may be configured to extract information from the route plan that corresponds to the unique machine identifier. For example, the unique machine identifier “X123” shown at 82 may correspond to the autonomous machine 16 shown in FIG. 2, while the unique machine identifier “Y456” shown at 84 may correspond to the manned machine 18 of FIG. 2. Thus, although the same information may be multicast or, alternatively, broadcast to all of the machines 16 and 18, each machine 16, 18 may be configured to extract and utilize only the information corresponding to the unique machine identifier, such as 82 and 84, assigned to the machine 16, 18.

The navigation unit 30 of each of the autonomous machines 16 may use the machine position information generated by the positioning unit 28 to maneuver the autonomous machine 16 according to the route plan. In particular, the navigation unit 30 may communicate with the electronic controller 26 to electronically control at least speed and direction of travel of the autonomous machine 16. The machine control system 24 also transmits the machine position information, such as, for example, by sending unicast messages 86 and 88, over the wireless network 74 and one of the first and second networks 38 and 40. The machine position information is received by the central control system 14 and used by the autonomous control server application to generate and/or update the route plan. It should be appreciated that each of the autonomous and manned machines 16 and 18 may be equipped with positioning units 28 and, thus, may be configured to transmit machine position information to the central control system 14. The autonomous control server application uses the machine position information from all of the machines 16 and 18 to effectively track and identify the machines 16 and 18 on the route plan. Each machine 16 and 18 may then be safely maneuvered at the work site 12 according to the route plan.

The electronic exchange of information, also referred to as “heartbeats,” between the central control system 14 and the machines 16 and 18 occurs at a predetermined frequency. For example, the route plan information may be transmitted once or twice a second, and the machine position information may also be transmitted once or twice a second. It should be appreciated that alternative frequencies may also be used. If the machines 16 and 18 do not receive an anticipated route plan, or heartbeat, after a predetermined period of time, the machines 16 and 18 may be configured to halt operations. If, however, the central control system 14 does not receive an anticipated machine position information, or heartbeat, from one of the machines 16 and 18, the autonomous control server application may be configured to designate that machine as a lost machine.

Turning now to FIG. 3, a graphical representation 90 of a work site 92 is shown. The work site 92 may include a plurality of paths 94 extending between a material site 96 and a production facility 98. Although a simplified 2-dimensional representation of the work site 92 is shown, it should be appreciated that a 3-dimensional representation of the terrain may be alternatively provided. The graphical representation 90 may represent portions of a route plan for one or more machines 100 at the work site 92 and, according to some embodiments, may include position information for all equipment, hazards, and other areas of interest at the work site 92.

The graphical representation 90 also depicts a lost machine 102, as described above. In particular, if the central control system 14 does not receive machine position information from the lost machine 102 within a predetermined period of time, the autonomous control server application will update the route plan to indicate an avoidance area 104 corresponding to the lost machine 102. The avoidance area 104 may be an estimate of the area that other machines 100 should avoid based on the last position known position of the lost machine 102 and the speed and trajectory at which the lost machine 102 was traveling. The avoidance area 104 may be referenced by both autonomous and manned machines 100 to safely navigate the work site 92.

The cluster of servers 46 are configured to identify a failure of the exactly one server 72 on which the autonomous control server application is executing, and restart the autonomous control server application on another of the cluster of servers 46 responsive to the failure. For example, a remaining subset 76 of the cluster of servers 46 may detect the failure of server 72 and, in response, may automatically restart the autonomous control server application on exactly one of the remaining subset 76 of servers. For example, the autonomous control server application may be restarted on server 78 or, more specifically, on the virtual component 54 of server 78. Thereafter, the autonomous control server application may transmit the route plan, which has been generated and/or updated by the autonomous control server application, to the machines 16 and 18.

The central control system 14 may be configured to identify a communication failure corresponding one of the first and second networks 38 and 40 and, in response, may transmit the route plan and machine position information over another of the first and second networks 38 and 40 in response to the communication failure. For example, if the first switch 42 is communicatively interconnecting the cluster of servers 46 with the first network 38, the second switch 44 may remain inactive. However, if a communication failure corresponding to the first network 38 occurs, the second switch 44 may become active, while the first switch remains inactive. Thus, communications at the central control system 14 may continue using the second network 40.

### INDUSTRIAL APPLICABILITY

The present disclosure finds potential application in any control system for a work site. Further, the present disclosure may be specifically applicable to central control systems that are communicatively coupled to autonomous machines at the work site. Yet further, the disclosure may be applicable to control systems for work sites including autonomous machines that require high availability. Such work sites may include mining environments utilizing autonomous and manned heavy equipment, such as excavators, backhoes, front-end loaders, mining shovels, etc., to excavate and transport materials from a mine site to a production facility.

Referring generally to FIGS. 1-3, a control system 10 for a work site 12 may generally include a central control system 14 communicatively coupled with a plurality of autonomous machines 16 and a plurality of manned machines 18 at the work site 12. Each of the autonomous and manned machines 16 and 18 may include a machine control system 24 including an electronic controller 26, a positioning unit 28, and a navigation unit 30. The navigation unit 30 of each of the autonomous machines 16 may use machine position information generated by the positioning unit 28 to maneuver the autonomous machine 16 according to a route plan. In particular, the navigation unit 30 may communicate with the electronic controller 26 to electronically control at least speed and direction of travel of the autonomous machine 16.

The machine position information from each of the machines 16 and 18 may be transmitted from the machines 16 and 18 to the central control system 14. In particular, the machine position information corresponding to the machines 16 and 18 may be transmitted over a wireless network 74 and one of a first network 38 and a second network 40. The first network 38 may include a first switch 42 interconnecting the first network 38 with a plurality of components of the central control system 14, while the second network 40 may include a second switch 44 interconnecting the second network 40 with the plurality of components of the central control system 14. The first and second switches 42 and 44 may be configured such that when a communication failure regarding the network 38 or 40 currently being used, the other of the networks 38 or 40 will be used for communication.

An autonomous control server application is executed on exactly one of the cluster of servers 46, such as, for example, server 72. According to a specific embodiment, the autonomous control server application may be operated on one of a plurality of virtualized servers 54 and may be managed using VMWare® HA software. The autonomous control server application may access one or more of the independent disks 58 of a RAID system 56 to generate and/or update a route plan for the one or more machines 16 and 18 operating at the work site 12. The route plan may be transmitted as a multicast message 80, as shown in FIG. 2, and received at the autonomous and manned machines 16 and 18. In particular, the multicast message 80 may be transmitted by the autonomous control server application over one of the first and second networks 38 and 40 and the wireless network 74.

This exchange of information between the machines 16 and 18 and the central control system 14 is crucial for safe and efficient operation at the work site 12. Thus, the cluster of servers 46 is configured to identify a failure of the exactly one server 72 on which the autonomous control server application is executing, and restart the autonomous control server application on another of the cluster of servers 46 responsive to the failure. For example, a remaining subset 76 of the cluster of servers 46 may detect the failure of server 72 and, in response, may automatically restart the autonomous control server application one exactly one of the remaining subset 76 of servers. For example, the autonomous control server application may be restarted on server 78 or, more specifically, on the virtual component 54 of server 78. Thereafter, the autonomous control server application may transmit the route plan, which has been generated and/or updated by the autonomous control server application, to the machines 16 and 18.

In addition, the central control system 14 may be configured to identify a communication failure corresponding one of the first and second networks 38 and 40 and, in response, may transmit the route plan and machine position information over another of the first and second networks 38 and 40 in response to the communication failure. For example, if the first switch 42 is communicatively interconnecting the cluster of servers 46 with the first network 38, the second switch 44 may remain inactive. However, if a communication failure corresponding to the first network 38 occurs, the second switch 44 may become active, while the first switch remains inactive. Thus, communications at the central control system 14 may continue using the second network 40.

The network architecture provided herein provides a high availability autonomous machine control system. By providing redundancy and high availability with respect to the server, storage, network, and power, the central control system described herein protects against application and service failures, along with system and hardware failures. Thus, in an environment, such as an autonomous machine work site, where continuous and dependent control communication is important, the disclosed control environment provides nearly seamless failover that reduces significant downtime and costs associated with rebuilding and reconfiguring failed control system and/or network components.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A control system for a work site including an autonomous machine, comprising:
a central control system including:
a cluster of servers configured to execute an autonomous control server application on exactly one of the cluster of servers;
a RAID system in communication with the cluster of servers;
a first switch interconnecting a first network with the cluster of servers, and a second switch interconnecting a second network with the cluster of servers; and
a UPS system interconnecting a power source with the cluster of servers, the RAID system, and the first and second switches; and
a machine control system supported on a chassis of the autonomous machine and communicatively coupled with the central control system via a wireless network and one of the first and second networks, wherein the machine control system transmits machine position information to the autonomous control server application and receives a route plan generated by the autonomous control server application;
wherein the autonomous machine maneuvers in the work site according to the route plan.

2. The control system of claim 1, wherein each of the cluster of servers includes a virtualized server, and the autonomous control server application operates on the virtualized server.

3. The control system of claim 2, wherein the central control system includes a blade system, and each of the cluster of servers corresponds to a blade server.

4. The control system of claim 1, wherein the route plan and the machine position information are transmitted at a predetermined frequency.

5. The control system of claim 4, wherein the route plan is transmitted as a multicast message.

6. The control system of claim 5, wherein the work site includes a plurality of autonomous machines and a plurality of manned machines, wherein each of the autonomous and manned machines transmits machine position information to the autonomous control server application and receives the route plan generated by the autonomous control server application.

7. The control system of claim 6, wherein each of the autonomous and manned machines is associated with a unique machine identifier, and the machine control system of each of the autonomous and manned machines is configured to extract information from the route plan pertaining to the corresponding unique machine identifier.

8. The control system of claim 4, wherein the autonomous control server application is configured to update the route plan to indicate an avoidance area corresponding to a lost machine if the autonomous control server application does not receive the machine position information from the lost machine within a predetermined period of time.

9. The control system of claim 1, wherein the cluster of servers is configured to identify a failure of the exactly one of the cluster of servers on which the autonomous control server application is executing, and restart the autonomous control server application on another of the cluster of servers responsive to the failure.

10. The control system of claim 1, wherein the central control system is configured to identify a communication failure corresponding to the one of the first and second networks, and transmit the route plan and the machine position information over another of the first and second networks responsive to the communication failure.

11. A method of controlling an autonomous machine at a work site, the method comprising:
executing an autonomous control server application on exactly one of a cluster of servers of a central control system;
transmitting machine position information generated by a machine control system from the autonomous machine over a wireless network and one of a first network and a second network, wherein the first network is interconnected with the cluster of servers via a first switch and the second network is interconnected with the cluster of servers via a second switch;
receiving the machine position information at the autonomous control server application;
transmitting a route plan generated by the autonomous control server application and based at least in part on the machine position information over the one of the first and second networks and the wireless network;
receiving the route plan at the machine control system of the autonomous machine;
maneuvering the autonomous machine in the work site according to the route plan using the machine control system;
detecting a failure of the exactly one of the cluster of servers using a remaining subset of the cluster of servers;
automatically restarting the autonomous control server application on exactly one of the remaining subset of servers with at least one of the remaining subset of servers in response to the failure; and
transmitting the route plan updated by the autonomous control server application over the one of the first and second networks and the wireless network after the automatically restarting step.

12. The method of claim 11, further including:
identifying a communication failure corresponding to the one of the first and second networks; and
transmitting the route plan and the machine position information over another of the first and second networks in response to the communication failure.

13. The method of claim 11, further including accessing data from a RAID system with the cluster of servers.

14. The method of claim 13, further including providing power from a power source to the cluster of servers, the RAID system, and the first and second switches through a UPS system.

15. The method of claim 11, further including operating the autonomous control server application on a virtualized server of the exactly one of the cluster of servers.

16. The method of claim 11, further including transmitting the route plan and the machine position information at a predetermined frequency.

17. The method of claim 16, further including transmitting the route plan as a multicast message.

18. The method of claim 17, further including:
transmitting machine position information from each of a plurality of autonomous machines and a plurality of manned machines over the wireless network and the one of the first and second networks; and
transmitting the route plan generated by the autonomous control server application and based at least in part on the machine position information from each of the autonomous and manned machines over the one of the first and second networks and the wireless network.

19. The method of claim 18, further including:
assigning each of the autonomous and manned machines a unique machine identifier; and
extracting information from the route plan at each of the autonomous and manned machines pertaining to the corresponding unique machine identifier using the machine control system.

20. The method of claim 16, further including updating the route plan to indicate an avoidance area corresponding to a lost machine if the autonomous control server application does not receive the machine position information from the lost machine within a predetermined period of time.
